(19) United States
(12) Patent Application Publication
(10) Pub. No.: US 2008/0162369 A1
(43) Pub. Date: Jul. 3, 2008

(54) System and method for online electronic negotiation

(76) Inventor: Ioan Mihai Oara, Cary, NC (US)

Correspondence Address: Ioan Mihai Oara, 110 N. Drawbridge Ln., Cary, NC, 27513, US

(21) Appl. No.: 11/646,795

(22) Filed: Dec. 28, 2006

(51) Int. Cl. G06Q 99/00

(52) U.S. Cl. 705/80

(57) ABSTRACT

Systems and methods for electronic negotiation and document version management including a network operable to provide communication between at least two remote communication devices and a server computer, and at least one item to be negotiated that is communicated between the users through a representation of the at least one item on the user interfaces, wherein each user has predetermined authorization and privileges for proposing modifications to the item through a negotiation account managed by software operating on the server.

### FIELD OF THE INVENTION

The present invention relates generally to systems and methods for negotiations and document version control. Further, the present invention relates to automatic management of remote, network-based electronic negotiation and document version control.

### DESCRIPTION OF THE PRIOR ART

Negotiation is an essential activity in many aspects of social life. It may involve commercial interests, as between the buyer and seller or between the provider and consumer of a service; it may involve legal interests, as in a legal settlement between conflicting parties; it may involve general government, political and social interests, as they are negotiated in a legislature; it may involve declarative documents like white papers, company strategy, company or organization constitutions; it may involve a biding process where one party asks for bids and multiple parties respond with proposals. Given the great variety of negotiations, there may be many other types.

While negotiations involve a great deal of subjective factors, which cannot be addressed by a software system, like emotions, threats or implied promises, if the negotiation results in one or more documents that must be signed, there are certain mechanics, activities and procedures which may be both regulated and supported by a software system. For instance, documents must be written and edited, proposals and counter-proposals must be transmitted between participants; documents must be legally signed, achieved and retrieved. Such activities may proceed in an unorganized, ad-hoc, spontaneous manner, in which case the participants to the negotiation may face a number of difficulties that may impede the pace of the negotiation process and the final results.

Here are some common difficulties in a classical negotiation, which is not aided by a supporting and regulating system:

Multiple versions of a document may become confusing to the point in which a party cannot recognize which is the latest version.

It is very difficult to reconstruct the history of the negotiation, although such a history is useful for understanding the position and negotiating style of another party.

One party may “sneak in” words or phrases which are relevant for the outcome, but hard to detect by the other parties.

In the case of multiple parties, some participants may receive the proposals or counter-proposals before or after other participants.

When the parties are at different remote locations, it is difficult to establish a virtual meeting place and time for interactions. Physical meetings are costly and conference calls are difficult to organize, and tend to over-involve some participants while excluding others from deliberations.

There are multiple existing Internet services that allow subscribers to enter into some kind of negotiation. At the simplest level, an Internet purchase is a negotiation in which one party displays a product or service with a certain required price and another party makes a decision to buy. In more sophisticated cases, the buyer and seller may engage in a bidding process, in which various parties make offers at certain prices. However, in all these cases the object of the negotiation is simply a number (price), not a complex free format document.

A number of inventions go beyond the simple offer-to-sell/offer-to-buy paradigm, by allowing parties to engage in more complex negotiations. For example:

US Patent Application 20060041483 describes a commercial negotiation system and method in which the object of the negotiation is a set of values associated with a product or service. The system is asymmetric, including a vendor on one side and multiple clients on the other. However, this does not mimic the actual negotiation of text documents, where parties with the same rights negotiate an actual free format text.

In a similar fashion, US Patent Application 20060041503 describes a negotiation method and system with bidders and clients where the object of the negotiation is again a numeric value, the price of a product or service.

US Patent Application 20050240529 describes a method and system for electronic negotiation of documents, but it is focused on the creation and reformatting of documents in an automatic manner. It assumes the existence of a number of legal document templates and an Internet service that would allow a requestor to require the server to customize it in accordance with the answers to a predetermined set of questions. This application also describes a negotiating facility. However, unlike the system and method described here, the consecutive versions of document are created based on questions and answers and not on direct editing of the document, as it usually happens in normal real life negotiations. The question-and-answer paradigm creates a number of limitations, while free editing allows maximum freedom for the creation of a text acceptable to all parties. Furthermore, the present invention offer a number of features not addressed by 20050240529, as for instance the capability to split the negotiation of the document into negotiations on separate items, the capability for multi-person parties formed by multiple subscribers with various rights, the capability for multi-party negotiations based on negotiation rules, the capability to review the negotiation history as recorded in a negotiation log.

### SUMMARY OF THE INVENTION

A first aspect of the present invention is to provide a system for online electronic negotiation including a network operable to provide communication between at least two remote communication devices and a server computer, wherein each of the at least two remote communication devices include a display and user interface viewable thereon by a user; at least one item to be negotiated that is communicated between the users through a representation of the at least one item on the user interfaces; wherein each user has predetermined authorization and privileges for proposing modifications to the item through a negotiation account managed by software operating on the server.

Another aspect of the present invention is to provide a method for online electronic negotiation including the steps of providing a system having software operable on a server computer for permitting online negotiation by at least two remote users accessing the system via remote computers having user interfaces viewable on a display; one of the users initiating a negotiation by introducing at least one item to be negotiated into an account; the other user viewing the at least one item to be negotiated and making a proposal to modify the item that is communicated to the initiating user; and the initiating user reviewing the proposed modification and either accepting or proposing another modification, which is communicated to the other user through the system.

These and other aspects of the present invention will become apparent to those skilled in the art after a reading of the following description of the preferred embodiment when considered with the drawings, as they support the claimed invention.

### BRIEF DESCRIPTION OF THE FIGURES

FIGS. 1-14 are user interface views for the method steps and system of the present invention.

### DETAILED DESCRIPTION

The present invention provides a system for online electronic negotiation including a network operable to provide communication between at least two remote communication devices and a server computer, wherein each of the at least two remote communication devices include a display and user interface viewable thereon by a user; at least one item to be negotiated that is communicated between the users through a representation of the at least one item on the user interfaces; wherein each user has predetermined authorization and privileges for proposing modifications to the item through a negotiation account managed by software operating on the server.

The present invention also provides a method for online electronic negotiation including the steps of providing a system having software operable on a server computer for permitting online negotiation by at least two remote users accessing the system via remote computers having user interfaces viewable on a display; one of the users initiating a negotiation by introducing at least one item to be negotiated into an account; the other user viewing the at least one item to be negotiated and making a proposal to modify the item that is communicated to the initiating user; and the initiating user reviewing the proposed modification and either accepting or proposing another modification, which is communicated to the other user through the system.

The systems and methods of the present invention address some of the difficulties mentioned above with the relevant art, while providing additional advantages. The purpose is to create an online facility that would support as much as possible all forms of interactions and activities involved in a document negotiation.

To describe the functionality of the system, both developers and users of the system may use the following definitions shown in Table 1:

TABLE 1

| Term | Definition |
|---|---|
| Negotiation | A series of activities performed by two or more |
| | parties with the support of the system which have |
| | the purpose of creating a mutually agreed |
| | document |
| Document | A formatted document which is the object of the |
| | negotiation. |
| User or subscriber | A permanent identity recorded in the system of a |
| | person who is the member of an account or of a |
| | party and participates in negotiations. |
| Negotiating account | A permanent identity recorded in the system |
| | which defines a person or a group which may |
| | enter a negotiation |
| Account member | A user who has some specific rights relative to a |
| | negotiating account or a party engaged in a |
| | negotiation. |
| Account administrator | A subscriber who is a member of an account and |
| | can add and remove account members from an |
| | account and define member's rights relative to the |
| | account. |
| Party | An entity defined in the context of a negotiation |
| | representing a specific interest relative to the |
| | document being negotiated. A party may consist |
| | of one or more members. A party must be |
| | associated with exactly one account. |
| Party member | A subscriber with specific rights relative to a |
| | party within a negotiation. |
| Party administrator | A subscriber who is a member of a party and can |
| | add and remove account members from an |
| | account and define member's rights relative to the |
| | account. |
| Document version | A particular version of the document being |
| | negotiated. Versions are sequenced in the order |
| | parties submit them. |
| Draft | The first version of the document |
| Negotiation | A party which has special privileges, like inviting |
| administrator | new parties, removing parties, configuring |
| | negotiation rules, or opening and closing a voting |
| | phase. One or more administrators may exist in a |
| | negotiation. |
| Negotiation log | A complete list of all visible actions of each party |
| | in the negotiation. The list of actions may include |
| | the initiation of the negotiation, the joining the |
| | negotiation by the second party, the submission |
| | of a proposal, and the signing the document. |

Definitions:

A series of rights and privileges of an account member are defined as such:

Administrator—A member who can add and remove other members from the account and define their rights and specify other properties of the account such as name, address and description.

May represent—The member may initiate a new negotiation or join a negotiation in which the party to which he belongs represents this account.

A series of rights and privileges of a party member are defined as such:

Administrator—A member who can add and remove other members from the party and define their rights and specify other properties of the party such as name, address and description.

May approve proposal—This member's approval is sufficient to submit a new version of the document as a proposal made by this party.

Must approve proposal—This member's approval is necessary in order to submit a new version of the document as a proposal made by this party.

May submit proposal—This member has the right to submit a new proposal in the name of the party, if the proposal is approved or if the party is set up such that it does not need approval for submission.

May sign—This member's signature is sufficient to mark the approval of the final version of the document by the party he represents.

Must sign—This member's signature must appear to mark the approval of the final version of the document by the party he represents.

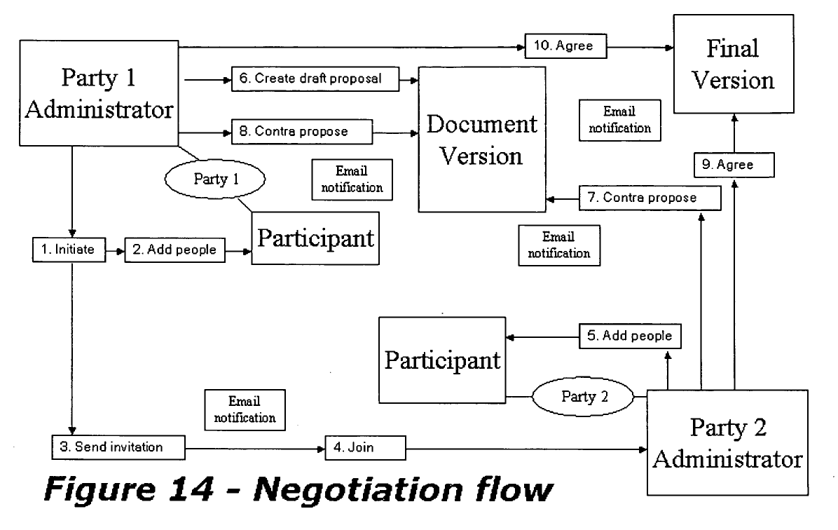

The system described by this invention would support a set of activities which would result in the negotiation of a document. These activities are performed in a particular flow, as indicated in FIG. 14:

A person may subscribe to the site which implements the invention and create a user id and password and registered all useful information, in particular the email address he or she uses o communicate during the negotiation.

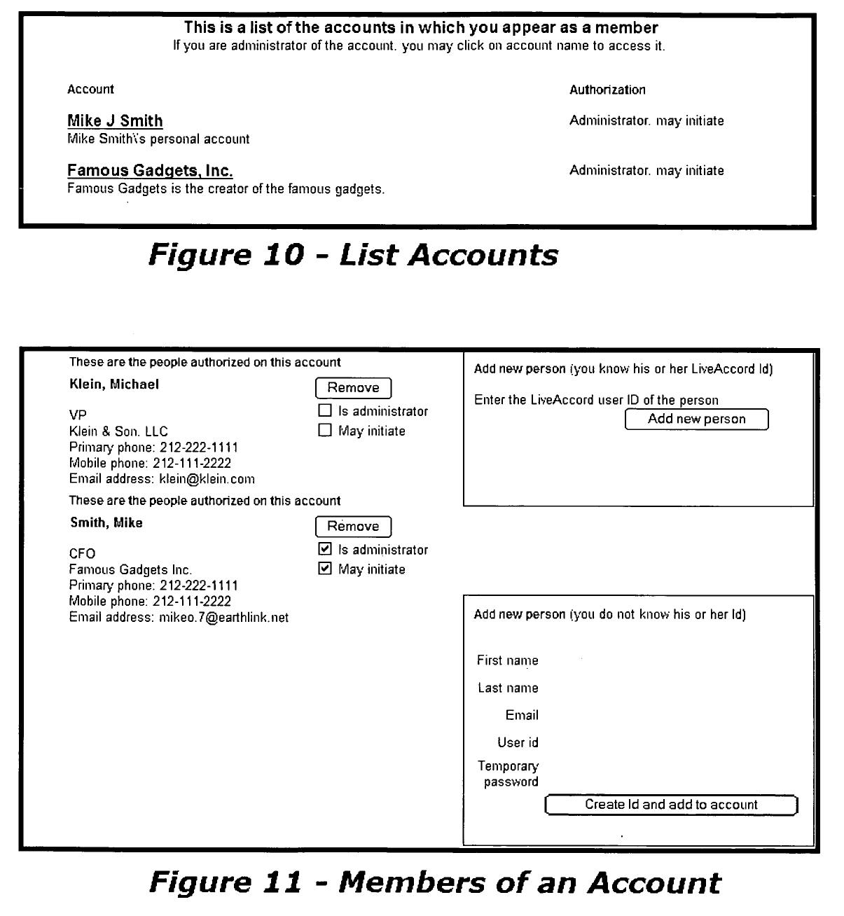

A subscriber may create a negotiating account, in which he may enter the information related to the party that he usually forms for a negotiation. In most common cases the account would represent the company for which he negotiates and the creator of the account is automatically the administrator of the account. The administrator of an account may add more users who are authorized to use the account for negotiation and may give them the right to initiate or join negotiations representing that account, as shown in FIG. 11. A user may participate in one or more accounts. As an example, a paralegal may create and administer the account, and add a number of company employees and outside lawyers to the account. Some of these participants may be given the right to initiate negotiations representing the account; some others may only have the right to participate in negotiations initiated by others. A lawyer may appear on more accounts as he may represent a number of companies. After a user signs in, he may view and select an account to which he is authorized, as shown in FIG. 10.

A user authorized to an account may create and maintain a set of document templates associated with the account. Such templates are useful in case the users associated with the account are entering in repeated negotiation with various parties, on the same type of agreement (for instance a sales contract, a non disclosure agreement, etc.). The templates are used as initial drafts in case a new negotiation is initiated. Alternatively, the system may provide itself a number of public document templates, to be used by any user on any account.

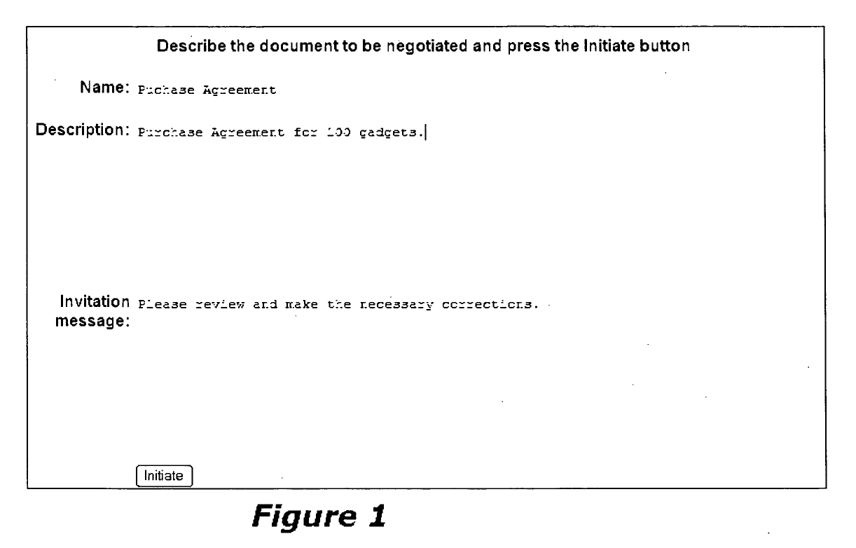

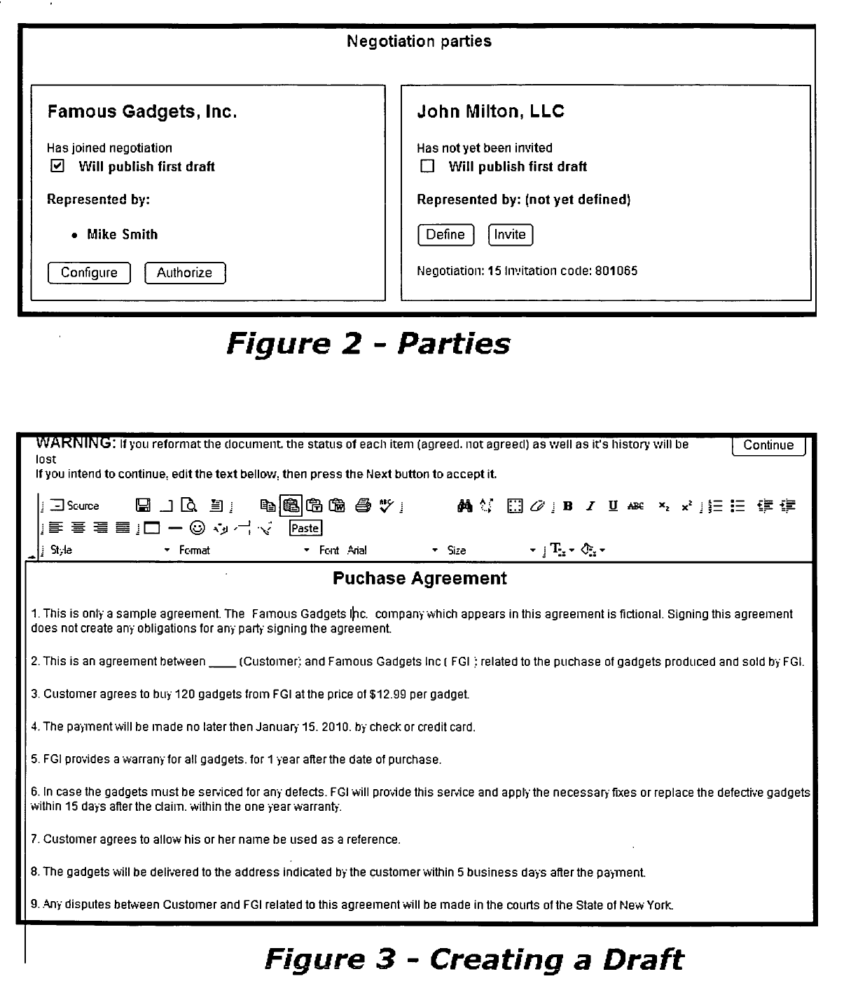

A user with proper rights may sign in, select an account (if he appears in multiple accounts) and initiate a negotiation from that account. He would have to give it a name (which may be the name of the document), as shown in FIG. 1 and specify the name of the other party to the negotiation. He indicates an email address of a contact person within that party. As a result, the system creates an access code required by the other party to join the negotiation. The access code is displayed as in FIG. 2, so it may be communicated verbally, or an email message may be generated automatically, which would give the other party all information needed to join.

The initiator of a negotiation is by default the administrator of the party he represents. As an administrator, he can add new members to the party, he can remove them and he can specify their rights during the negotiation. He can also give administrative rights to other participants in the party, as shown in FIG. 13.

Finally, after all this information was entered, he may invite the other party to negotiation either by automatically sending an email message (if a contact email was indicated) or by communicating the details through other means (manual email, telephone, regular mail, etc.). The invitation message will indicate a negotiation ID and a special invitation code generated by the system, which would play the role of a password allowing the party to join.

A subscriber may join a negotiation to which he was invited, provided he has the necessary access information. To join, he must first sign in, then choose a special Join function to enter the access information, which may be, as indicated on the point above, the id of the current negotiation and an invitation code supplied by the initiator of the negotiation, as shown in FIG. 5. If this data is not correctly entered, the subscriber receives a message and cannot join the negotiation; if the data is correct, he gets access to the negotiation and he becomes by default the administrator of the party he is representing.

A subscriber who is the member of a party may submit an initial draft of the document. The draft of the document may initially exist as an external document in a common format, such as Microsoft Word or RTF. The system allows the user to copy and paste this outside document in a special HTML editor text area, as shown in FIG. 3, where it is converted to HTML format. The operation of copying a formatted text into an HTML text area and reformatting it as HTML is supported by all major Internet browser and is not subject of this invention. An HTML text editor is a common tool implemented and made available either by particular vendors or exists as open source software, and it may be employed in the system described by this invention. Alternatively, the user my write the draft text directly into the HTML editor. When a draft is entered in the HTML editor, weather by direct typing or by copy and paste, the system identifies all contiguous text portions and marks them with sequence numbers so that the system may track them as separately negotiable items, keeps track of their status (agreed or disagreed) and also keeps an individual history of each item. The identification of contiguous text as separate from the HTM formatting tags may be done by employing regular expression searches. Such a regular expression may be “|>([̂<]+)<|U”, which would return an array with all the text chunks and their position in the HTML document. The system would then introduce an HTML button tag in front of the text of the item. This button will display as text the item sequence number and the change status of the item (“unchanged since last version”, “changed by my party”, “changed by the other party”). The change status of an item may be made visible in a variety of ways, including the in text, image or color. As a result of this transformation, the first version of the document is created.

When a user creates a new version of the document as a new proposal, this version is visible to all the members in his party, but is not visible to the other parties. Because of this, the party members may all review the proposal and confer about its content, before submitting it. Furthermore, if the party is set such that one or more members must approve, the submittal cannot happens before the appropriate approval. All members of the party who have the “must approve proposal” right must approve the proposal before it is submitted. If a member of the party has the “may approve” right, then he may by himself approve the proposal. The approval may be implemented by the system as the action of pressing a button or a link on a particular page. The system will only perform the submission after the party member rights are checked and the system establishes that the member who attempts to approve has the right to do so.

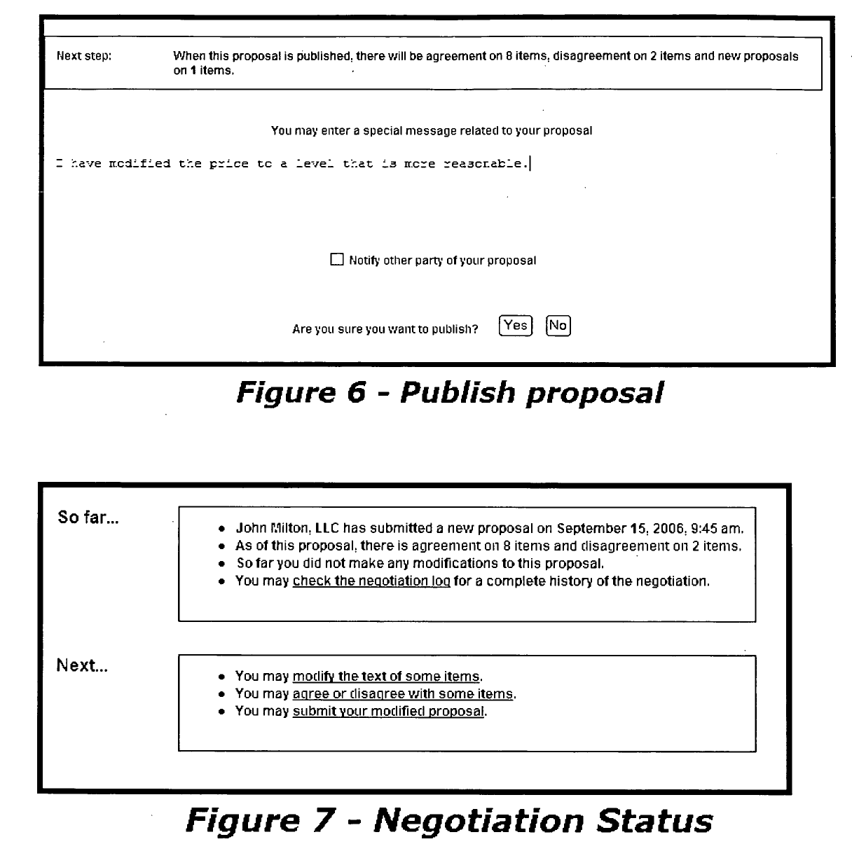

Once a new proposed version is prepared by a party and it is approved (or otherwise does not need approvals), a member with “may submit proposal” rights may submit it, as shown in FIG. 6. When the proposal is submitted, the new proposed version becomes visible to the other parties, who may evaluate it and decide to accept it or make new proposals. The submission may be implemented as the action of clicking on a button or on a link in a page.

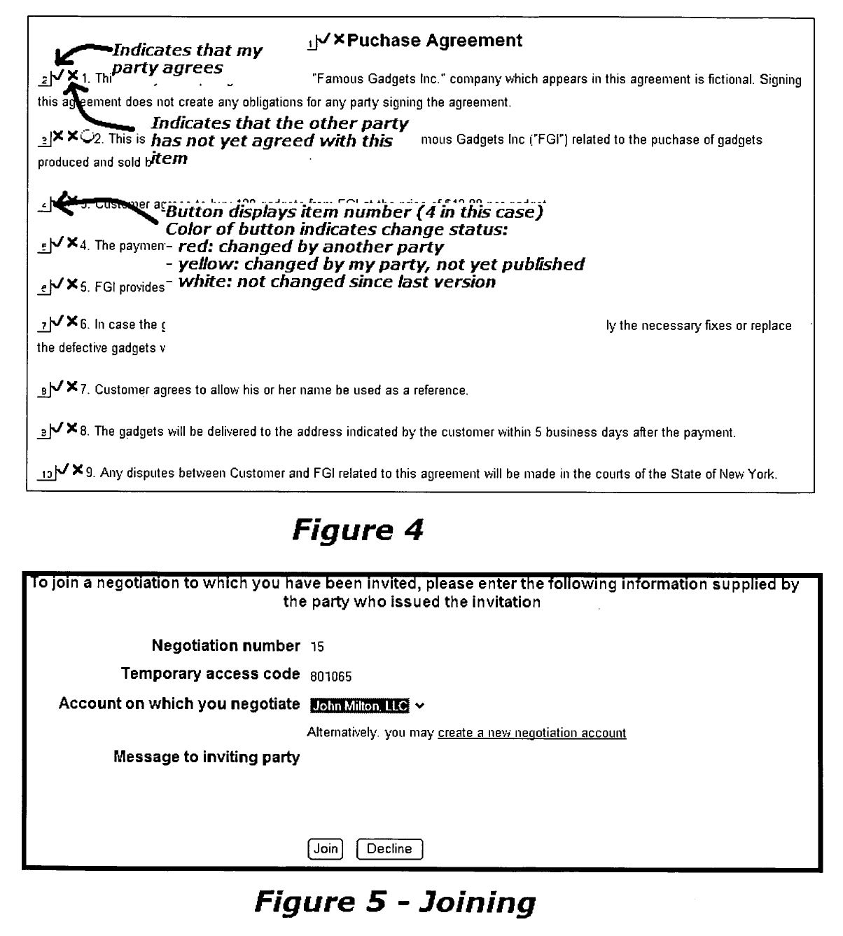

Each item in the document will have markings, as in FIG. 4, that indicate (a) change status (who changed the item), (b) approval status (is the item approved or disapproved by the parties to the negotiation). In a particular implementation, the change status may appear as a small button with colors (white—not changed, red—changed by opposite party, yellow—changed by own party), while the approval status may appear as two small images, first indicating if approved by own party, second if approved by the other party. The images may be, for example, a check mark for approved and an X sign for rejected.

As a party receives a new proposal, the members of the party may process the proposal by (a) changing some the text of some items, and (b) by modifying the approve/disapprove status. In a particular implementation, to process a particular item, the user may click on the item to receive a new page on which the text of the item may be modified. Checkboxes may be used to indicate approval or disapproval of the item.

Alternative proposals are submitted by the parties until all items are agreed. At that point the system signals the agreement on all items and allows parties to either submit new proposals or in the most common case to sign the document.

The system allows the user to see the current status of the negotiation. Current status shows who is the last party who made a proposal and how many items are in agreement or disagreement, as shown in FIG. 7,

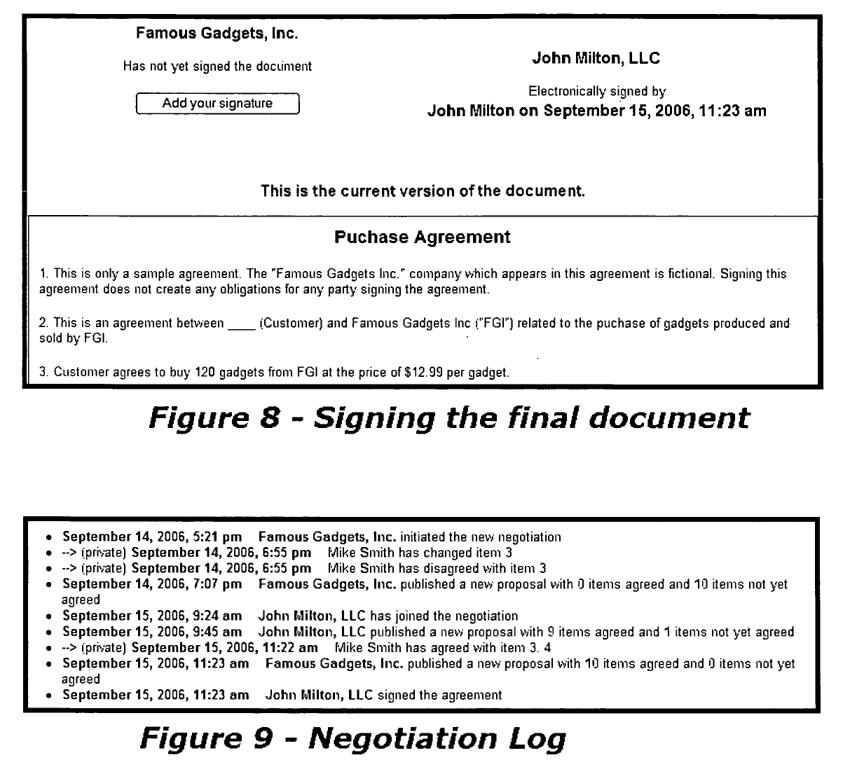

The signing happens when a member of the party with proper right to sign is pressing a specific Sign button or link, as shown in FIG. 8. The “Sign” button is available only when all items were agreed, and only to authorized members. The system keeps track of all signatures.

A number of signatures may be gathered from the subscribers who are authorized to sign for one of the parties. They are released and made visible to the other party by a subscriber with proper authority to submit proposals and signatures.

If one party signed and another submits yet another proposal, the first party signature is suspended until there is agreement on the last modified proposal. The fact that a party has signed is signaled by the system to the other party (for instance by an automatically generated email message). After both parties have signed, the document is locked and no party may retract the signature or submit new proposal. The negotiation of the document is effectively ended.

The system keeps track and displays on request a log of the negotiation. The log will indicate (a) when the negotiation was initiated, (b) when each party was invited, (c) when each party has joined, (d) when each proposal is submitted, (f) when each party signed the document, (g) when the document is frozen and the negotiation is concluded.

For each in the negotiation process, each party may be configured to receive automatic email notifications. As an example, a party will receive a notification that the other party has submitted a new proposal.

The negotiation log may be displayed on request, as shown in FIG. 9. The negotiation log is displayed as a list of steps with some additional information and possible links to other pages with additional details about that step. For example, a step in the log may indicate that a party submitted a proposal that agrees with a number of items on the previous version and proposes changes on a number of other items. When a subscriber clicks on the line showing the action, it may go to a separate page where the corresponding version of the document is displayed. In this way, each party may always go back and see the complete history of the negotiation and use the information to come with better proposals.

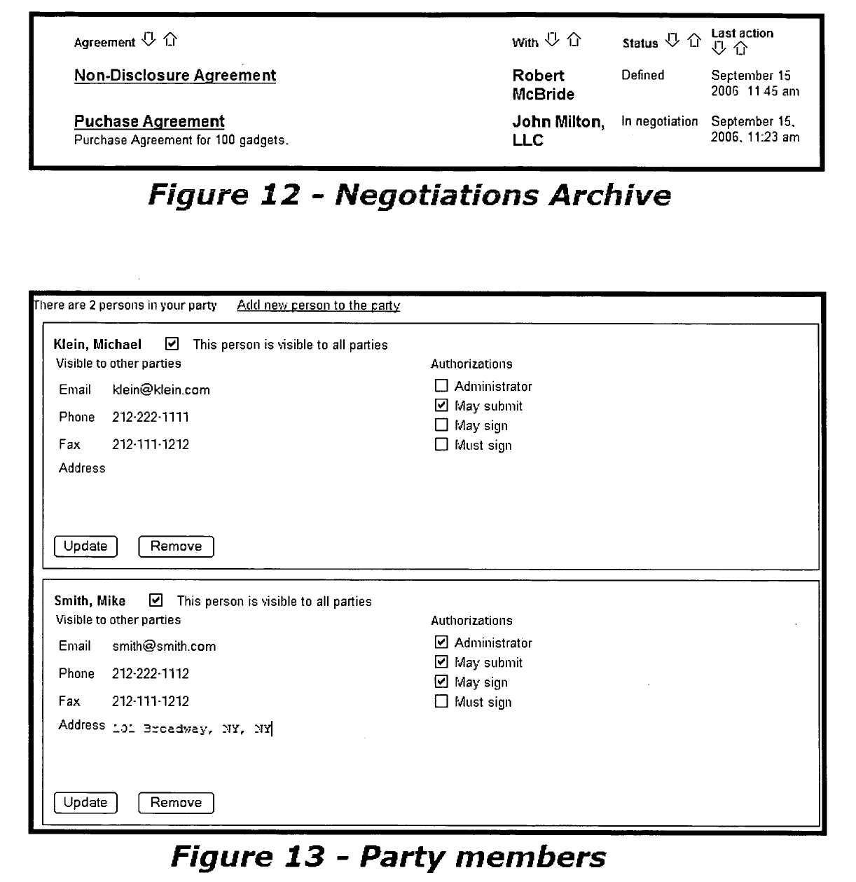

A subscriber may sign in and view a list of all negotiations (concluded or in progress) to which he is authorized. The subscriber can sort this list by document name, by negotiation status or participating party or by the date of the last step in the negotiation. This functionality allows subscribers to effectively keep an archive of all negotiations. One possible implementation of this is shown in FIG. 12.

The present invention provides a system for online electronic negotiation of a document between two parties, each party consisting of a number of participants with various degrees of authorization to view, propose, submit and sign versions of the document. In systems and methods of the present invention, the following steps and structure support preferred embodiments for the present invention.

At the start of a negotiation, a user, a person or an organization may establish a negotiation account representing it, such that an account may have a number of authorized users who can negotiate or view negotiations initiated on this account.

A user may log in to an account and initiate or join an online negotiation of a document, so that in such a negotiation his party represents the account.

A user initiates a negotiation, he defines two parties, of which the first represents the account to which the user is sign in and the other is configurable, such that the user may indicate an email address for the other party and automatically send an email message inviting somebody to join the negotiation and represent the second party, the message containing all the information needed for the second party to join the negotiation, including a unique access code.

A user who initiates a negotiation or is the first user to join a negotiation on behalf of a party is automatically the administrator of the party who can add more participants to the party, selectively granting each user the right to see the negotiation, the right to make proposals, the right to submit proposals, the right to sign the final version approved by both parties and the right to add or remove users from the party.

A user can create an initial draft of the document either by writing the text in an editor provided by the system, or copying and pasting from another document into this editor, or by using a number of templates either provided by the system or created previously and associated with an account to which the user is authorized.

An authorized the user in a party can modify a version of the negotiated document in order to create a new proposal, such that this proposal is visible to all users in his party but not to the users in the other party; an authorized user may publish the last version representing the last proposal from his party, so that it becomes visible to all users in both parties; an authorized user may sign the document on behalf of the party and make the signature visible to all participants in both parties.

Negotiated document text is divided in separate items that can be individually changed and negotiated and colors or other markings are used to allow the user distinguish between the items in the negotiated document which are agreed upon by both parties and the items for which there is disagreement.

A log is created and viewable by users, showing each step of the negotiation with the time and date and the party that took the step, including the initialization of the negotiation by one of the parties, the invitation for the other party to join, the joining of the negotiation by the second party, the alternate proposals from each party and the signing of the final agreed version by each party.

A user may see a list of all negotiations to which he is authorized, including the ones which are defined but not yet started, the ones which are currently active or in negotiation and the ones which are concluded; the user can sort this list by negotiation status (defined, joined, started, concluded), by document name, by opposing party or by the date of the last step in the negotiation; the user can select a negotiation from the list and view all available information, including the history of the negotiation, the signatures (in case it was concluded) and in the case the negotiation is in progress, proceed to view the latest proposal or make a new proposal.

The present invention also provides a system for the online negotiation of a document, which allows the user to create a document in an editor and automatically split the document in individual items, such that the document could be displayed with special markings identifying each item; the markings may appear as buttons or images or hyperlinks, such that when the user clicks on a marking for an item the item is presented in an editor where the user can modify it; when the document is viewed by the user, the markings of each item are such that the user may distinguish between the items which were not modified, or were modified by himself or were modified by another party; separate markings showing if the text of an item is approved by each of the parties who have an interest in the final text of the document; the user may approve or disapprove of any particular item, by modifying the corresponding marking.

This invention provides software and methods for an online facility that allows subscribers to engage in the negotiation of a document or a series of documents. The participants to the negotiation are organized in two, each party representing a particular interest vis-à-vis the document being negotiated. Each party may consist of one or more persons (users, subscribers), who also have configurable rights and privileges inside the party; for instance, a person may be authorized to invite new people to the party, to approve proposals, to submit proposals or to sign the final document as a representative of the party. To facilitate the forming of parties, users may create accounts in which the information about the party and the people authorized to participate in various negotiations is defined in advance.

Negotiations proceed in a number of phases, all performed online via this facility, as for instance, (a) the definition of the negotiation, (b) definition of participating parties, (c) invitation of parties, (d) parties joining the negotiation, (e) creation and submission of an initial draft, (f) multiple iterations in which the parties submit proposals until all items in the document are agreed upon, (g) signing of the documents. As successive version of the negotiated document are submitted, they are always broken into separate items in such a way that the system is able to keep track on the number of items agreed and disagreed and also to clearly mark which items were modified by a party and needs attention and which items were accepted and being settled need no more attention. All the documents, both intermediate and final versions are archived, such that an individual subscriber who participated in a negotiation may see a log of how this negotiation evolved and recall any of the intermediate or final versions, including signatures. The documents being negotiated may be contracts that define commercial or legal obligations, they may be simple documents that require the collective participation of a number of authors or may be bids submitted by a number of parties for a particular commercial or government project.

Certain modifications and improvements will occur to those skilled in the art upon a reading of the foregoing description. The above mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the following claims.

What is claimed is:

1. A system for online electronic negotiation comprising:
a network operable to provide communication between at least two remote communication devices and a server computer, wherein each of the at least two remote communication devices include a display and user interface viewable thereon by a user;
at least one item to be negotiated that is communicated between the users through a representation of the at least one item on the user interfaces;
wherein each user has predetermined authorization and privileges for proposing modifications to the item through a negotiation account managed by software operating on the server.

2. The system of claim 1, wherein the at least one item to be negotiated is selected from the group consisting of a term, document, diagram, drawing, and combinations thereof.

3. A method for online electronic negotiation comprising the steps of:
Providing a system having software operable on a server computer for permitting online negotiation by at least two remote users accessing the system via remote computers having user interfaces viewable on a display;
one of the users initiating a negotiation by introducing at least one item to be negotiated into an account;
the other user viewing the at least one item to be negotiated and making a proposal to modify the item that is communicated to the initiating user;
and the initiating user reviewing the proposed modification and either accepting or proposing another modification, which is communicated to the other user through the system.
